(19) United States
(12) Patent Application Publication
(10) Pub. No.: US 2025/0387952 A1
(43) Pub. Date: Dec. 25, 2025

(54) PREFORM MADE OF A THERMOPLASTIC MATERIAL AND DEVICE AND METHOD FOR PRODUCING A PREFORM

(71) Applicant: Mahir AKTAS, Balcova-Izmir (TR)

(72) Inventor: Mahir AKTAS, Balcova-Izmir (TR)

(21) Appl. No.: 18/879,519

(22) PCT Filed: Jul. 10, 2023
(86) PCT No.: PCT/EP2023/069045

§ 371 Date: Dec. 27, 2024

(30) Foreign Application Priority Data
Jul. 13, 2022 (DE) 10 2022 117 474.3

(51) Int. Cl. B29B 11/08; B29B 11/14; B29C 49/00

(52) U.S. Cl. CPC B29B 11/08; B29B 11/14; B29C 49/071; B29C 2949/0725; B29C 2949/0747; B29C 2949/078; B29C 2949/22; B29C 2949/28

(57) ABSTRACT

A preform is made of a thermoplastic material and is used to manufacture blow-molded containers. The preform has a tube-like central area, a closed bottom and a mouth section. The mouth section lies opposite the bottom in the direction of a longitudinal axis and defines an interior space. The wall thickness in the area of the bottom is at least partially smaller than in the central area. In the region of an inner or outer surface, the bottom has at least one protrusion and optionally a web. The axial web extends from a center of the bottom in the direction of the central area. The vertical web can connect at least two axial webs with each other or be designed alone. The protrusion and the optional webs are formed by a melting chamber and flow channels following the material feed via the sprue.

The present invention relates to a method and a device for producing preforms for shaping an advantageous preform dome geometry for the subsequent blow molding process.

The invention ultimately leads to significant savings in raw materials and also improves the quality of the finished product.

The invention also relates to a preform or a preform with improved bottom geometry.

Preforms are injection-molded blanks made of at least one thermoplastic material that are used in blow molding machines for the production of stretch blow-molded plastic containers.

For the production of preforms described in accordance with the present invention, plastic raw material is plasticized and then pressed at high pressure into a single-cavity or multi-cavity mold.

According to the state of the art, preforms are produced as shown in FIG. 1, which essentially consist geometrically of a neck and shaft area and a bottom dome, and which are hollow on the inside due to the use of a core in the mold. The neck area is shaped in such a way that it can be re-closable with a screw cap, for example.

However, the neck area does not undergo any further changes during the blowing process. The shaft area and the bottom dome, on the other hand, are blown into hollow bodies at elevated temperatures, whereby the plastic is stretched and solidifies considerably. Therefore, the preform areas to be formed are geometrically responsible, together with the core geometry, for the bottle quality that is achieved later.

The mold is usually the largest investment in a production system. For this reason, great importance is attached to its efficient operation. The preform, whose outer skin is in direct contact with the intensively cooled mold steel and therefore solidifies there quickly, is demolded without damage or mechanical deformation so that the mold is ready for the next production cycle without any loss of time.

It should be noted that during the injection molding process, a holding pressure is maintained throughout the preform via the sprue in order to compensate for this deficiency during the solidification process of the preform, which is accompanied by shrinkage and thus leads to a lack of material, in order to avoid unwanted sink marks on the molded part.

During the usual fast production cycles, considerable residual heat remains inside the preform wall, which leads to reheating, causing the preform to re-soften and crystallize, rendering it unusable.

It is therefore very advantageous to continue cooling the preform intensively in simpler mold parts, so-called cooling sleeves, during several production cycles after demolding.

The preform as shown in FIG. 1 corresponds to the current state of the art, in which, as described, it is inevitable that the wall thicknesses of the preform have similar wall thicknesses, particularly in the area of the preform dome and the shaft. If the material freezes prematurely due to thinner wall thicknesses in the bottom area or in the neck area, shrinkage cannot be avoided in the cooling phase by forcing the melt through, with an effect on the entire preform including the neck area, which consequently leads to undesirable sink marks in critical areas of the preform.

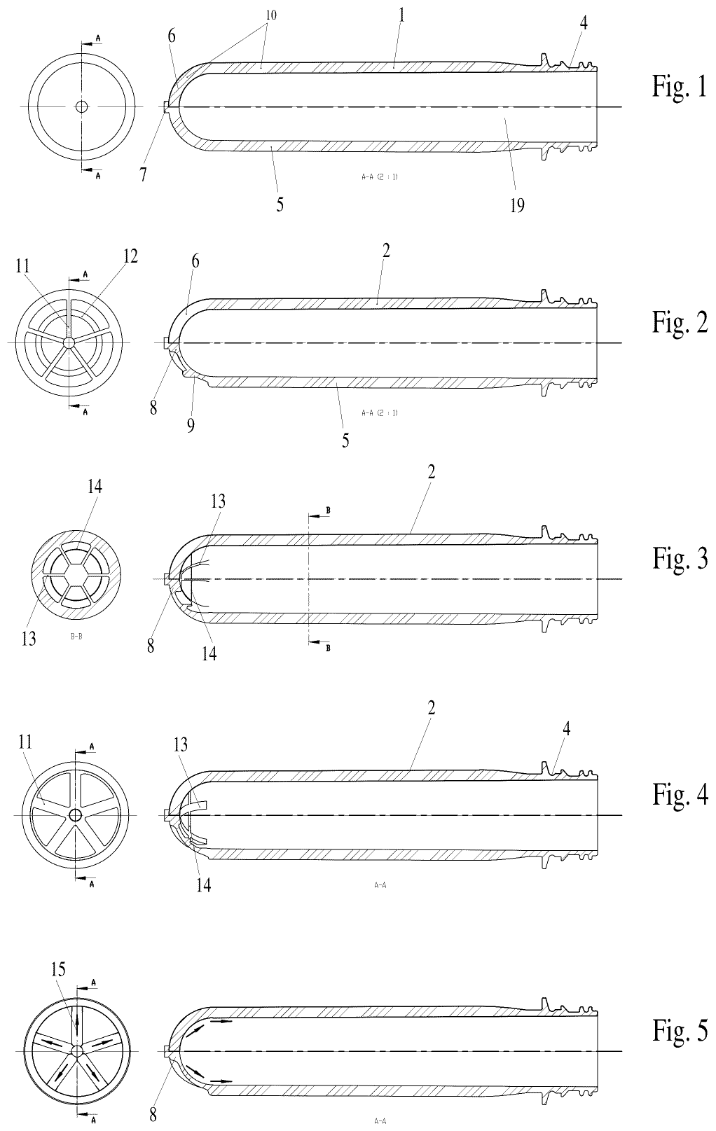

The preform geometry according to the invention, as shown in FIG. 2 and the advantages of which are explained below, can therefore not be produced using the known injection molding process, or only if appropriate measures are taken to maintain the required holding pressure, since this invention achieves a significantly thinner wall thickness in the preform dome than in the subsequent shaft area in order to prevent premature freezing in these thin areas and to avoid sink marks.

A further criterion for the subsequent blow molding process is that the temperature profile between the preform dome and the shaft would have to make an abrupt temperature jump of approx. 50 to 80° C. for an optimum result, which is hardly feasible with the current state of the art. In most cases, this means that the material in the bottom area cannot be optimally drawn off into the bottle body during the stretch blow molding process due to a gradual temperature transition, which leads to unnecessary material consumption. This could be greatly optimized by thinner wall thicknesses in the preform dome, but rapid freezing in the thin area during the injection molding process means that the holding pressure in the neck or neck finish cannot be maintained, which would then lead to the aforementioned sink marks and the neck would no longer form a tight system in line with closures.

The central object of the present invention is to describe a method and a device with which preforms with significantly more favorable wall cross-sections in the preform dome can be produced. The advantage lies in the fact that the infrared heaters of the downstream blow molding machines can introduce thermal energy more efficiently via this now enlarged surface area with simultaneously reduced wall thickness in order to bring the plastic in this area to a stretchable temperature more quickly. This means that during the stretch blow molding process, the material can be optimally extracted directly from the preform dome in favor of the bottle bottom or body, which enables significant savings in raw materials.

Preforms according to the present invention can be cooled more efficiently in the mold, since there is a smaller wall thickness between the melting chamber and the flow channels, and the flow channels have a larger surface area. An exception to the more efficient cooling is the area of the melting chamber, as here the melt receives a higher residual heat than the rest of the preform area due to the reduced cooling in the mold. The melt is injected through the sprue directly into the larger melting chamber, where it is collected as if in a basin and then diverted into the rest of the preform body in a controlled manner. The melting chamber thus guarantees a continuous filling of the preform with melt and, during the holding pressure phase, its design supports the even distribution of the melt into the subsequent thinner wall thickness area. The melt is guided evenly through the melting chamber, as if through a screen, either to the corresponding flow channels or directly into the thinner wall thickness area of the preform dome. If the melting chamber is optimally designed, the flow channels can even be omitted in coordination with the respective bottle bottom geometry. A higher cooling efficiency is also achieved in the post-cooling of the robotics, as a larger cooling surface can be used in the cooling sleeve of the removal robotics for the preform dome with a simultaneously reduced wall thickness, which counteracts softening and the associated reduction in quality. Due to the protrusion and the respective optional webs, which are formed by the melting chamber and optional flow channels in the outer preform dome, the cooling sleeve of the robotics can better accommodate the preform during the transfer from the mold to the robotics. The preform dome has a larger contact surface to the cooling sleeve and this ensures more efficient preform cooling.

In addition, a special preform dome design can be used to accommodate the respective container bottom geometry. During the blow molding process, the stretching rod contacts the preform dome in the inner sprue area, cooling it in an uncontrolled manner and thus preventing optimum stretching of the bottom area. Due to the protrusion and the webs around the inner sprue area, which are created by the inner melting chamber and the optional vertical and/or horizontal flow channels in the mold, an optimized stretching of the preform dome can be achieved according to the invention with an adapted stretching rod geometry, in coordination with the constructive bottle bottom design. It is also possible to dispense with the respective internal flow channels if a correspondingly larger internal melting chamber is used in the mold. After the sprue, the melting chamber is located directly in the future preform body, i.e. the melt is collected here and then evenly distributed into the rest of the preform. In this case, the melt is fed directly via the melting chamber into the thinner wall thickness areas without flow channels. This leads to better shaping around the sprue or bottle bottom area of the blow-molded bottle, thus avoiding abrupt differences in wall thickness and material accumulation, which in turn can lead to so-called stress fractures at the bottom of the bottle, especially with beverages containing gas.

With the protrusion and the optional integrated webs, the surface area of the inner and/or outer preform dome can be increased over the entire bottom area. This has the advantage that the infrared heaters of the downstream blow molding machines can introduce thermal energy more efficiently via the increased surface area and the material can be pulled out of the preform dome more easily. The stretching rod of the blow molding machine can better influence the wall thickness of the bottle bottom through better guidance or centering, as well as the precisely defined design of the inner protrusion and the webs, so that the preform can be precisely lengthened axially.

Three solutions are proposed below for the production of such preforms, which are used either in the bottom plate and/or core of the mold.

In a first variant, it is possible in the area of the bottom plate of the mold, for example, to shape the outer preform dome in such a way that the largest part in the transition of the sprue to the preform base is actually thin-walled, but at least one melt space, optionally two or more flow channels are designed either axially and/or vertically in such a way that they do not freeze prematurely and can thus maintain the holding pressure to the preform shaft. The purpose of the melting chamber around the sprue area is to guide the melt more optimally into the respective flow channels or the thin-walled wall thickness area of the preform dome in order to ensure uniform distribution of the melt.

The size of this melting chamber depends on the preform size, weight, geometry and the quality requirements of the respective blown bottles. The preform dome formed by the melting chamber and the flow channels can appear on the outside of the preform as protrusions or webs, which do not have a negative effect on the subsequent blowing process, provided they are distributed as symmetrically as possible around the circumference. In the stretch blow molding process and later on the bottle, they can even have a stabilizing effect. In addition, the protrusion and the optional webs in design variants one and three are visible on the outside of the finished product and visually indicate the savings.

Flow channels with the aim of influencing the bottle geometry are known from the state of the art, e.g. in WO 2010/06 9042 A1 and U.S. Pat. No. 5,455,088. In both documents, flow channels are described which have an influence on the bottle body and bottle bottom. The flow channels start directly at the preform sprue and end inside the preform shaft. The advantage of the two above-mentioned designs is that, according to the present invention, a melting chamber is filled first and only then is the melt distributed into the thinner preform dome area or into the respective flow channels in order to ensure uniform filling of the preform.

In addition, the axial flow channels can be connected vertically to support the dimensional stability of the preform in the holding pressure phase. Furthermore, the flow channels all end in the area of the preform dome without weakening the wall thickness of the future bottle feet. This enables uniform axial stretching and better temperature distribution in the preform dome without creating large jumps in wall thickness between the preform sprue and the outlet to the cylindrical preform body.

An alternative second variant, which the invention describes here, is possible in the core of the mold, for example, to shape the preform inner design in such a way that the largest part of the inner preform dome is actually thin-walled, but at least one inner melting chamber and optionally two or more flow channels, either axially and/or vertically, are designed in such a way that they do not freeze prematurely and can thus maintain the holding pressure to the preform shaft. By adapting or reducing the core cooling at the preform dome, the melting chamber and the flow channels can support the preform shaft with melt for longer during the holding pressure phase in order to avoid sink marks. When designing the flow channels, it is important to avoid undercuts so as not to jeopardize the demolding of the preform, as for example in WO 2016/059135 A1, since the preform cannot be demolded here due to an undercut. These flow channels appear on the inside of the finished preform dome as webs, which do not have a negative effect on the subsequent blowing process, provided that they are distributed as symmetrically as possible around the circumference, but actually have a stabilizing effect in the stretch blow molding process and later on the container. In addition, the inner protrusion and the webs, which are formed by the melting chamber and the flow channels of the mold, are not visible from the outside of the finished product, which is a major difference to the first and third approaches. If the bottle bottom design allows it, flow channels can be dispensed with and only an internal melting chamber in the mold can be used.

A third variant for optimizing the preform according to this invention in the bottom area is to combine a melting chamber and external and internal flow channels in the preform dome. For this purpose, the bottom plate and the core are adapted together in the mold. This means that an inner/outer melting chamber, axial and/or vertical flow channels can be introduced at the same time. Particularly in CSD (Carbonated Soft Drinks) applications, where high internal pressures act, a more stable bottle bottom with a lower weight can be achieved through targeted preform dome designs or the insertion of a melting chamber and a combination of axial/vertical outer flow channels and/or corresponding inner flow channels.

The invention is explained in more detail below and with reference to the accompanying drawings based on examples of embodiments. The drawings show:

FIG. 1 A preform in cross-section as it is usually produced according to the state of the art.

FIG. 2 A preform outer contour in cross-section in which the preform dome was designed during the injection molding process in the mold as an example in such a way that it has at least one outer protrusion, two axial and/or one vertical web, which are visible on the finished container.

FIG. 3 Preform inner contour in cross-section in which the bottom area was designed during the injection molding process in the mold so that they have at least one inner protrusion, two axial and one vertical web, which are not visible from the outside on the finished container.

FIG. 4 A combination of preform outer and inner contour in cross-section in which the bottom area was designed during the injection molding process in the mold so that they have at least one protrusion, two axial outer webs and at least one axial/vertical inner web.

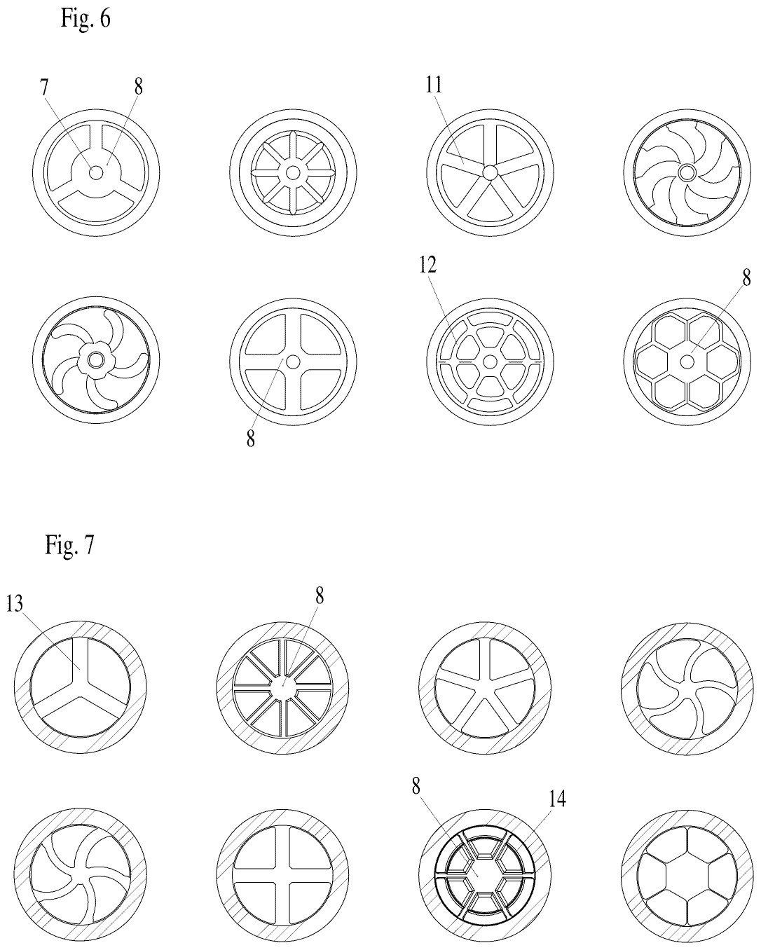

FIG. 5 A schematic representation of the flow paths on the preform dome from the outside and from the side.

FIG. 6 A top view of an exemplary production arrangement for preforms with an outer protrusion and outer webs.

FIG. 7 An internal view of an exemplary production arrangement for preforms with an inner protrusion and inner webs.

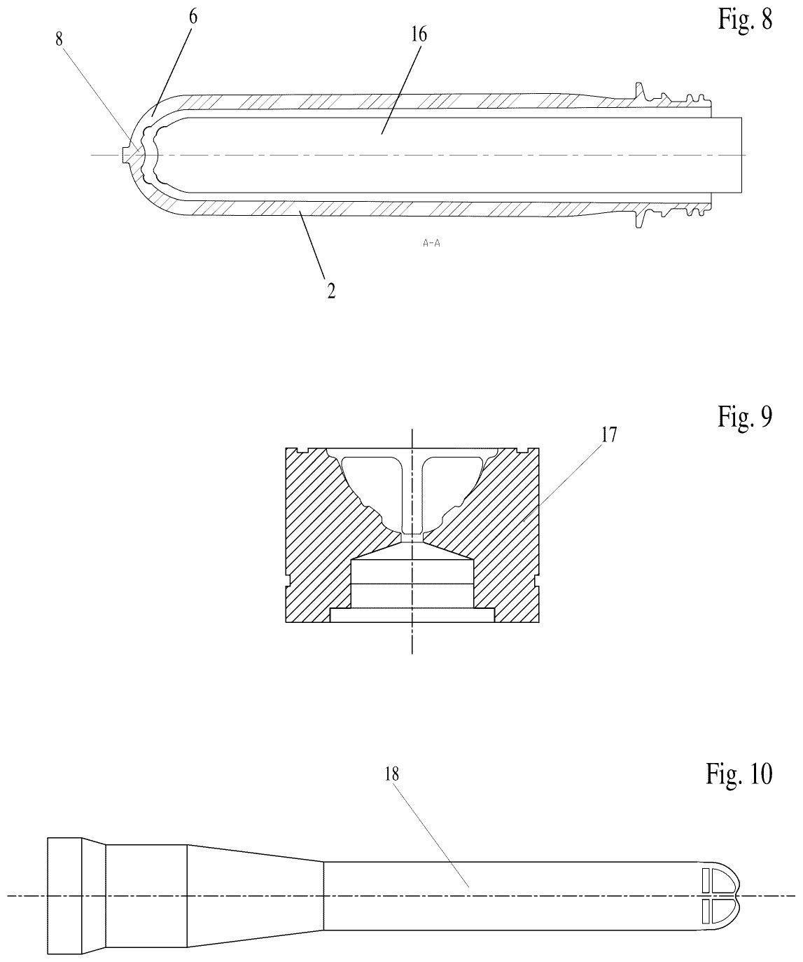

FIG. 8 A preform inner contour with a recess for an inner protrusion and vertical bar in cross-section with retracting horizontal bar.

FIG. 9 A bottom plate with a recess for a melting chamber and axial/vertical flow channels.

FIG. 10 A core with a recess for a melting chamber and axial/vertical flow channels.

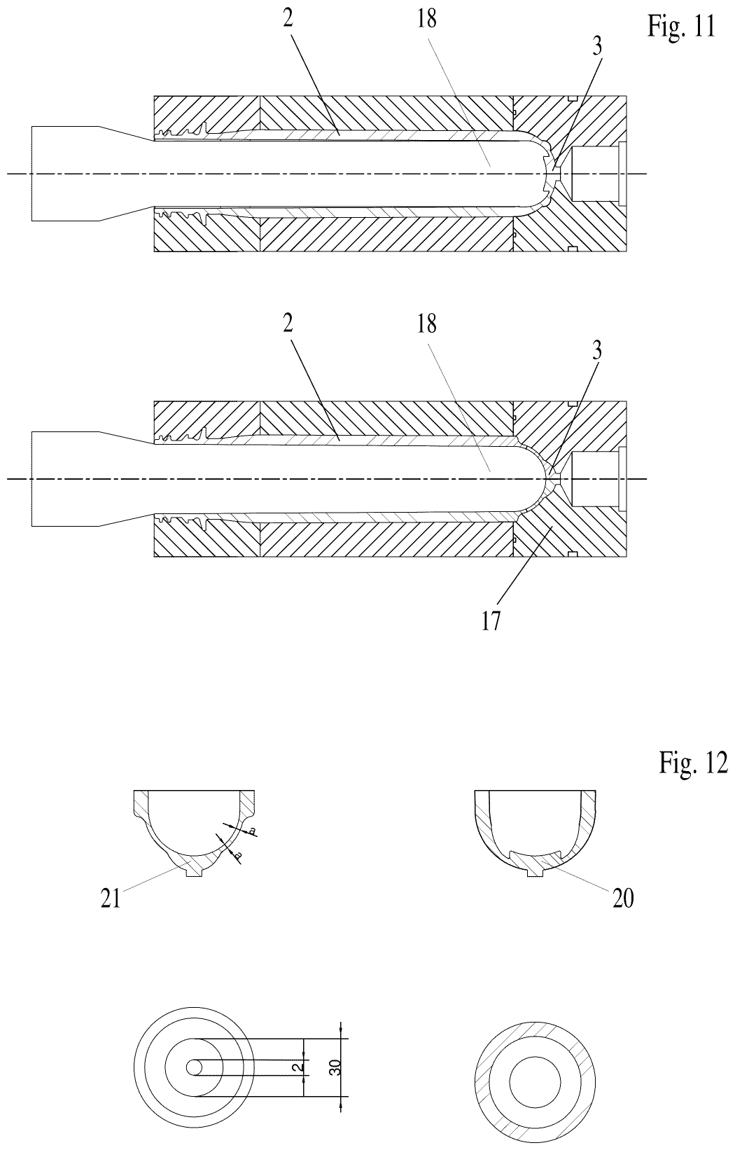

FIG. 11 A mold cavity for an injection molding machine with melting chamber.

FIG. 12 Different inner/outer protrusion geometries.

The drawings below are intended to support the explanation of the manufacturing process of the preform dome area.

All the design details and process details explained below can be implemented individually or in any combination with one another in accordance with the invention. All device features can also be used in the context of the method and all method features can be implemented in the device.

FIG. 1 shows a preform (1) manufactured according to the prior art. A wall thickness (10) in a preform dome (6) below a sprue (7) has a similar wall thickness (10) as in a shaft area (5). Preforms optimized for the blow molding process according to FIG. 2 with reduced wall thicknesses (9) in a bottom area (6) can only be produced by injection molding with restrictions due to the risk of the melt freezing, as the holding pressure, which counteracts the shrinkage of the preform (2) during the cooling process, can then no longer act in the decisive areas.

In this invention, three solution variants are shown as to how the preform (2) in FIG. 2 can be produced. It should be mentioned that all three methods produce at least one inner/outer melting chamber, optional outer axial/vertical flow channel and/or optional inner axial/vertical flow channel at the circumference of the described preform dome (6), which, however, have no detrimental effects on the desired blowing result when the preform (2) is blow molded. On the contrary, in variants one and three, the molded protrusions and optional webs on the preform are visible from the outside and suggest increased strength, even though material has been saved. In addition, with an adapted bottle bottom geometry in the mold, external/internal flow channels can be completely dispensed with and only an external or internal melting chamber can be used. The melt flows from the sprue directly into the melting chamber, which is not located in the material feed of the mold, but always only after the sprue area, in a protrusion of at least 2 mm to 30 mm diameter (FIG. 12) in the future preform dome, as a material distribution center. The hot melt flow is not cooled immediately here but is first diverted evenly into the adjoining thin-walled area, comparable to a screen, and cooled in a controlled manner by an adapted tool cooler until the holding pressure process is complete.

In order to be able to produce a preform (2) as shown in FIG. 2 using conventional injection molding technology, a mold cavity as shown in FIG. 11 with a melting chamber and optional flow channels is designed in such a way that at least one protrusion (8), two or better five outer axial webs (11) and/or an outer vertical web (12) are formed over the thin wall (9) in the preform dome (6). The structural design during the injection molding process, as shown in FIG. 2, supports the maintenance of the holding pressure in the bottom area (6) of the preform (2). The surface contour of the preform (2) is continued in the area of the webs, whereas in the area of the recess the contour falls on the inside or outside and thus generates a lower wall thickness (9) in the area of a recess.

The preform dome (6) has a uniform wall thickness in the sprue area, has a protrusion (8) which is formed by a melting chamber (3) in the mold and ensures a continuous distribution of the melt, which is then fed into the preform shaft (5) via the flow channels, which appear as webs (11, 12, 13, 14) on the preform, in the mold cavity through recesses.

Ideally, the axial flow channels lead directly into the shaft of the preform or, depending on the bottom design of the container to be produced, can end freely definable between the sprue (7) and the shaft area (5). This compensates for any advance of the melt and avoids unwanted weld lines. The vertical flow channels, visible on the preform as webs (12, 14), connect at least two axial flow channels, visible on the preform as webs (11, 13), in order to guide the melt simultaneously via the flow channels into the preform shaft (5) during the holding pressure phase. In addition, the vertical flow channels support the bottle bottom stability in the subsequent blowing process in order to compensate for uncontrolled stretching caused by the different wall thicknesses between the melt chamber and the respective flow channels. It is also possible to use only one vertical flow channel, visible on the preform as webs (12, 14), with the aim of obtaining more material at a certain bottle bottom section in order to support the dimensional stability of the bottle bottom.

What is important here is that these surfaces do not have to be excessively long in the axial direction, but that the radial cross-sectional surface in the area of the thin sections already ensures the desired abrupt heat transfer over a short length for the blowing process. This has the advantage that the design of the thin sections can usually be carried out entirely in the split shaping parts of the preform dome. In addition, the flow channels, visible on the preform as webs (11, 12, 13, 14), are relatively short due to this design, which simplifies the thermal and rheological design of these flow channels in such a way that early freezing within the flow channels and the formation of weld lines decreases with decreasing length.

In order to make the axial flow channels narrower, however, at least one additional vertical flow channel can also be integrated into the mold cavity as a connecting element between the axial flow channels, as shown in FIGS. 2, 3 and 4 by the webs (11, 12, 13, 14), which then support the shaping of the preform (2) during the holding pressure phase. However, only an outer vertical and/or only an inner vertical flow channel can also be introduced at the same time.

The preform (2) in FIG. 3 shows the second solution variant, in which the webs are inserted in the inner contour of the preform (2) so that they are not visible from the outside of the blown bottle and at least two, preferably six, axial inner webs (13) and at least one vertical inner web (14) are integrated into the preform dome (6) in order to secure the holding pressure during the injection process via the melting chamber (3) in the preform bottom area.

FIG. 4, on the other hand, shows a combination of outer and inner webs. The webs (11, 13 and 14) continue the original surface contour of the preform (1). The protrusion (8) on the preform is created by a melting chamber (3) in the mold and ensures the optimum supply of melt to the preform (2) with the simultaneous, parallel insertion of the inner/outer flow channels, visible as webs (11, 13), whereby the outer and inner flow channel contours match in terms of shape, such as width and length, and adapt to the surface contour of the preform (2). This prevents sink marks in the shaft (5) and neck area (4) during the holding pressure phase.

The flow paths (15) in FIG. 5, marked by arrows, show how the melt flows via the sprue into the melting chamber (3), visible here as a protrusion (8), and from there via five flow channels (visible here as webs) of sufficient width and length into the preform shaft, thus maintaining the holding pressure. The melt first collects in the subsequent melting chamber (3), which, due to its larger diameter (FIG. 12) than in the sprue (7), keeps the melt at a constant temperature, as in a tank, in order to prevent premature cooling of the melt from causing sink marks in the neck area (4) or even in the shaft area (5) before the injection molding process or holding pressure is completed.

FIG. 6 and FIG. 7 show webs with different inner contours and outer contours with different design options. The different geometries of the protrusion (8), axial (11, 13) and vertical (12, 14) web can be clearly seen.

FIG. 8 shows a stretching rod (16) during a stretching process in the retracting position. The stretching rod (16) meets the inner protrusion (8) and a vertical web (14) of the inner preform dome (6) when it enters the preform (2). The inner contour of the axial/vertical web can match the outer contour of the stretching rod geometry to ensure that the preform (2) can be precisely lengthened axially. This has the advantage that the preform sprue of the container is always exactly centered and wall thickness differences in the container base due to shifted sprues (7), so-called off-centers (preform sprue is shifted off-center from the axial container center) are avoided.

In the injection mold, the inner/outer melting chamber, the axial/vertical, inner or outer flow channels can be placed in a bottom plate as shown in FIG. 9 or in the core as shown in FIG. 10. FIG. 11 shows a complete mold cavity with an inner and outer melting chamber (3). This can be created either by respective recesses or enlargements, the future wall thickness of the preform (2), by adjustments in the bottom plate (17) and/or in the core (18).

FIG. 12 shows two different shapes of protrusions (8) without inner/outer webs. The outer diameter of the outer/inner protrusion (20, 21) is at least 2 mm up to a maximum of 30 mm before the transition into the thin-walled wall thickness area (9) of the preform dome starts and ends in the transition to the preform shaft (5). In this case, the thin-walled wall thickness area is designed with a constant wall thickness a between the protrusion and the transition to the preform shaft. Depending on the size of the inner/outer protrusion, it can either be designed with a constant wall thickness “a” or with a tapering or increasing wall thickness a up to the transition to the preform shaft. In this example, the inner protrusion (20) opens directly into the thinner wall thickness area (9) of the preform dome.

### LIST OF REFERENCE SYMBOLS

1 Preform according to the state of the art
2 Preform with optimized, thin-walled bottom area
3 Melting chamber
4 Neck area
5 Shaft area
6 Preform dome
7 Sprue
8 Protrusion
9 Reduced wall thickness in the preform dome
10 Normal wall thickness for the injection molding process
11 Axial flow channel on the preform outer contour
12 Vertical flow channel on the preform outer contour
13 Axial flow channel on the preform inner contour
14 Vertical flow channel on the preform inner contour
15 Flow path
16 Stretching rod
17 Bottom plate
18 Core
19 Interior of the preform
20 inner protrusion
21 external protrusion

1-17. (canceled)

18. A preform made of a thermoplastic material for producing blow-molded containers, comprising: a tubular central region; a closed bottom; and a neck region that lies opposite the bottom in a direction of a longitudinal axis of the preform and delimits an interior, wherein a wall thickness in a region of the bottom is dimensioned to be less, at least in some regions, than a wall thickness in the central region, wherein the bottom has, in a surface region of a surface, at least one inner/outer protrusion and optionally an outer or inner web with a constant wall thickness which, starting from a center of the bottom, extends in a direction of the central region.

19. The preform according to claim 18, wherein the protrusion and the optional web are arranged on the inside with respect to an inner space of the preform.

20. The preform according to claim 18, wherein the protrusion and the optional web are arranged on the outside with respect to an inner space of the preform.

21. The preform according to claim 18, wherein the webs are arranged on the inside and outside with respect to an inner space of the preform.

22. The preform according to claim 18, wherein the preform is an injection-molded material.

23. The preform according to claim 18, further comprising a sprue arranged in a region of an outer center of the bottom.

24. The preform according to claim 18, wherein the wall thickness in the region of the bottom is approximately 20 to 70% less than in the central section, at least in certain regions.

25. The preform according to claim 18, wherein the protrusion and the optional inner and outer webs are configured as additional reinforcement for the bottom without reducing the wall thickness in the area of the bottom.

26. An apparatus for injection-molding production of a preform from a thermoplastic material for the production of blow-molded containers, comprising: an outer mold; and a core arranged in a cavity of the outer mold, wherein the outer mold has a bottom and a neck region lying opposite the bottom in a direction of a longitudinal axis, wherein a distance between the core and an inner side of the outer mold in the region of the bottom is at least partially smaller than between the core and a central section of the outer mold, wherein at least one recess for a melting chamber and optionally a groove-like flow channel extends from a center, the recess being made in the mold after material feed, directly after a sprue, and having a larger diameter than the sprue, the recess being created either by a core or bottom plate and having an inner or outer melting chamber in the mold cavity, which is recognizable on the molded preform as an inner or outer protrusion.

27. The device according to claim 26, wherein the recess for the melting chamber and the optional flow channel on the core extends from the center of a dome.

28. The device according to claim 26, wherein the recess for the melting chamber and the optional flow channel on the outer mold extends from an inner center.

29. The device according to claim 26, wherein a distance in the region of the bottom is about 20% to 70% smaller than in the region of the middle section.

30. The device according to claim 26, including a melting chamber arranged in the region of the bottom.

31. A method for producing a preform from a thermoplastic material for producing blow-molded containers, which has a tubular central region, a closed bottom and a neck region, which lies opposite the bottom in a direction of a longitudinal axis and delimits an interior space and in which a wall thickness in a region of the bottom is dimensioned to be at least partially less than in the central region, the bottom having, in a surface region, at least one melting chamber and optionally a flow channel, which extends from a center of the bottom in the direction of the central region, the method comprising: providing an outer mold; arranging a core in a cavity of the outer mold; and injecting the thermal plastic material into the outer mold in an injection molding process.

32. The method according to claim 31, including generating a holding pressure in a final phase of the injection molding process.

33. The method according to claim 31, including filling a melting chamber with plasticized plastic.

34. The method according to claim 33, including, during the injection molding process, after the material has been fed via a sprue, first filling the melting chamber, which is larger in diameter, with thermoplastic and then filling a spacer region between the core and the outer mold with thermoplastic.
